(19) United States
(12) Patent Application Publication
(10) Pub. No.: US 2018/0193786 A1
(43) Pub. Date: Jul. 12, 2018

(54) HAND HELD APPLIANCE

(71) Applicant: Dyson Technology Limited, Wiltshire (GB)

(72) Inventor: Nathan Haruna Waters IMHASLY, Bath (GB)

(73) Assignee: Dyson Technology Limited, Wiltshire (GB)

(21) Appl. No.: 15/863,294

(22) Filed: Jan. 5, 2018

(30) Foreign Application Priority Data
Jan. 6, 2017 (GB) 1700224.7

(51) Int. Cl. B01D 46/00; A45D 1/04; A45D 20/12; B01D 46/24; B01D 39/12

(52) U.S. Cl. CPC B01D 46/0024; A45D 1/04; A45D 20/12; B01D 2279/45; B01D 39/12; B01D 2267/40; B01D 46/24

(57) ABSTRACT

A hand held appliance comprising a handle having a fluid inlet at a first end, the fluid inlet comprising an external grille and a filter wherein the external grille is retained with respect to the filter by an attachment mechanism which comprises a first pair of connectors and a second pair of connectors wherein the first pair of connectors and the second pair of connectors are spaced apart and different. The first pair of connectors and the second pair of connectors may have different functions. The first pair of connectors may comprise a first part and a second part which mechanically interlock. The first part and second part may mechanically interlock during relative rotation. The mechanical interlock may be releasable. The first part may be biased towards the second part.

### REFERENCE TO RELATED APPLICATIONS

This application claims the priority of United Kingdom Application No. 1700224.7, filed Jan. 6, 2017, the entire contents of which are incorporated herein by reference.

### FIELD OF THE INVENTION

This invention relates to a filter scheme for a hand held appliance and in particular for a hair care appliance.

### BACKGROUND OF THE INVENTION

In a conventional hot styling appliance, air is drawn into an inlet by a fan unit and directed towards the hair by an outlet. Often, one appliance is provided with different attachments, each having a different outlet and thus a different function, for example drying, curling or volumising. Depending on the style desired, the air may or may not be heated. The attachment may include bristles onto which hair is wrapped and held for styling. Conventionally a filter is provided to filter fluid that enters the appliance to remove dust and hair.

### SUMMARY OF THE INVENTION

According to some embodiments, a two layer filter system has a removable outer filter with a robust connection between the removable filter and the appliance.

According to a first aspect, a hand held appliance comprises a handle having a fluid inlet at a first end, the fluid inlet comprising an external grille and a filter wherein the external grille is retained with respect to the filter by an attachment mechanism which comprises a first pair of connectors and a second pair of connectors wherein the first pair of connectors and the second pair of connectors are spaced apart and different.

Different means that the connectors are dis-similar, disparate, distinct or non-identical and refers to the attributes of the connectors; they may be physically different and/or may be actuated by a different motion of the external grille with respect to the appliance.

Having spaced apart connectors provides a more robust connection between the two parts. There is also less tendency for misalignment between the filter grille and the handle. The function of retaining the filter grille can be separated from the function of aligning of the filter grille and the handle. Spaced part can be radially or circumferentially spaced around the filter grille and handle and/or longitudinally spaced along or parallel to a longitudinal axis of the appliance.

Preferably, the first pair of connectors and the second pair of connectors have different functions.

In a preferred embodiment, the first pair of connectors comprises a first part and a second part which mechanically interlock. Preferably, the first part and second part mechanically interlock during relative rotation. Preferably, the mechanical interlock is releasable.

In a preferred embodiment, the first part is biased towards the second part.

Preferably, the first part comprises a pivotable arm.

In a preferred embodiment, the first part comprises a retention pip (also referred to herein as a retention detente) which is provided on the pivotable arm.

Preferably, the second part comprises a recess adapted to accommodate the retention pip.

In a preferred embodiment, the external grille comprises one of the first part and the second part and the filter comprises the other one of the first part and the second part.

Preferably, the external grille comprises the second part.

Preferably, the external grille has a radially inner surface and a radially outer surface and wherein a protrusion extends radially inwards of the radially inner surface.

In a preferred embodiment, the protrusion extends gradually radially inwards around a portion of the circumference of the external grille.

Preferably, the protrusion comprises a recessed portion.

Preferably, the filter comprises the first part of the connector.

Preferably, the first part comprises a pivotable arm having a first end pivotally attached to the filter and a second end which is free to move and comprises a retention pip. The filter may comprise a radially outer surface which is accessible to a user when the external grille is removed; portions of the radially outer surface engage with the external grille to retain it with respect to the filter. Thus, the retention pip is preferably located on the radially outer surface of the filter.

Preferably, when the external grille is rotated in one direction with respect to the filter, the retention pip engages with the protrusion and the second end of the arm deflects allowing further relative movement until the recessed portion is reached wherein the arm pivots towards an undeflected state and the retention pip is housed within the recessed portion.

It is preferred that a relative movement in another direction reverses the engagement allowing the external grille to be removed from the filter.

It is preferred that the second connector comprises a third part and a fourth part.

Preferably, the third part comprises a cooperating slot. Preferably, the cooperating slot extends in first direction and a second direction. In a preferred embodiment, the handle extends along a longitudinal axis X-X and the first direction is parallel to the longitudinal axis. Preferably, the second direction is substantially orthogonal to the first direction.

Preferably, the first pair of connectors and the second pair of connectors are longitudinally spaced apart. In a preferred embodiment the handle extends along a longitudinal axis X-X and the first pair of connectors and the second pair of connectors are spaced apart along the longitudinal axis.

It is preferred that the fourth part comprises a flange. Preferably, the external grille has a radially inner surface and a radially outer surface, wherein the flange comprises face which extends substantially orthogonally and radially inwards of the radially inner surface. In a preferred embodiment, the cooperating slot comprises a further face adapted to engage with the face of the flange when the external grille is retained with respect to the filter.

Preferably, the filter comprises at least one ridge extending between the filter and the filter grille. It is preferred that the at least one ridge is located distal to the attachment mechanism. Preferably, the at least one ridge is located adjacent the outer wall of the handle. The at least one ridge centralises the filter grille with respect to the outer wall of the handle.

In a preferred embodiment, the appliance is a hair care appliance and preferably, a hot styling device or a hairdryer.

### BRIEF DESCRIPTION OF THE DRAWINGS

The invention will now be described by way of example, and with reference to the accompanying drawings, of which:

FIG. 1 shows an example of an appliance on which an attachment mechanism according to the invention can be used;

FIG. 2 shows an isometric view of a filter according to the invention;

FIG. 3 shows an alternative isometric view of a filter according to the invention;

FIG. 4 shows an isometric view of a filter grille according to the invention;

FIG. 5 shows a cross section through an isometric view of a filter grille according to the invention;

FIG. 6 shows a cross section through a second pair of connectors according to the invention;

FIG. 7 shows a cross section through a first pair of connectors according to the invention;

FIG. 8 shows an isometric view of a part of an alternative attachment mechanism according to the invention;

FIG. 9 shows a top view of an alternative filter grille according to the invention;

FIG. 10 shows a cross section through the alternative attachment mechanism;

FIG. 11 shows a cross section through the filter grille of FIG. 9;

FIG. 12 shows an alternative cross section through the filter grille of FIG. 9;

FIG. 13 shows a side view of part of the alternative attachment mechanism; and

FIG. 14 shows an appliance on which the alternative attachment mechanism may be used.

### DETAILED DESCRIPTION OF THE INVENTION

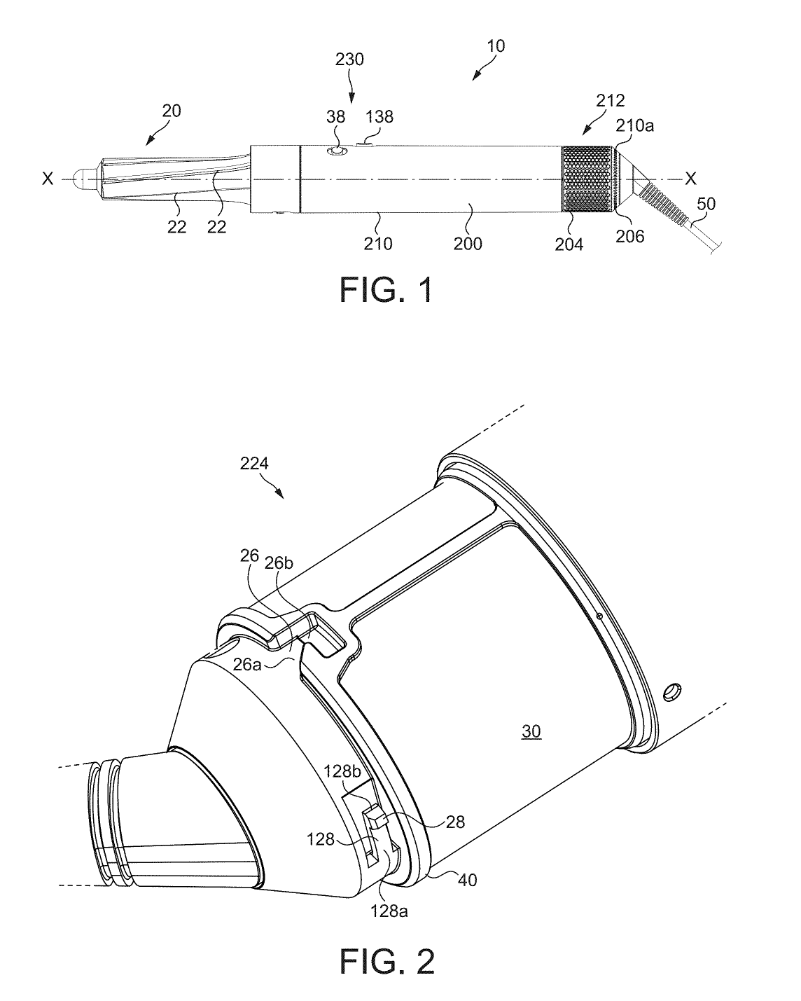

Referring to FIG. 1, an example of a hand held appliance 10 is shown. The appliance 10 is a hot styling device and has a handle 210 and an attachment 20 for styling hair. In order to enable a user to create different styles and to give the appliance multi functionality, the attachment 20 is removable and can be replaced with an alternative attachment. In addition, the attachment 20 can be removed to allow easier storage of the appliance when not in use.

The handle 210 has an outer wall 200 which a user holds and this provides a user interface (UI) 230 comprising a number of different user operated buttons 38, 138 enabling the user to select between a number of different heat and flow settings. The outer wall 200 contains a fan unit and heater (both not shown). In use the fan unit draws fluid in through a fluid inlet 212, along an internal fluid flow path, through the heater which optionally heats the fluid which is then emitted by the fluid outlet 22 in the attachment 20. Power is supplied to the appliance 10 via a power cable 50 which extends from the appliance to a plug (not shown) at the distal end. The power cable 50 connects to the appliance 10 at the fluid inlet 212.

In this embodiment, the fluid inlet 212 to the handle 210 has a double layer of filtration before fluid enters the internal fluid flow path of the handle 210. The outer wall 200 includes a filter grille 204 and internal to this is a filter 224. The filter 224 is finer and has smaller apertures than the filter grille 204 and is adapted to catch dust and fluff. The filter grille 204 is removable to enable the filter 224 to be cleaned periodically. Both the filter grille 204 and the filter 224 have an array of apertures that extend continuously radially around the circumference of the handle 210. In addition, the filter grille 204 has one or more rows of apertures 206 that extend around the handle end 210a which is distal to an attachment 20.

The filter grille 204, in this example is completely removed from the appliance 10, and retained on the power cable 50. In order that the filter grille 204 remains attached during use an attachment mechanism is provided.

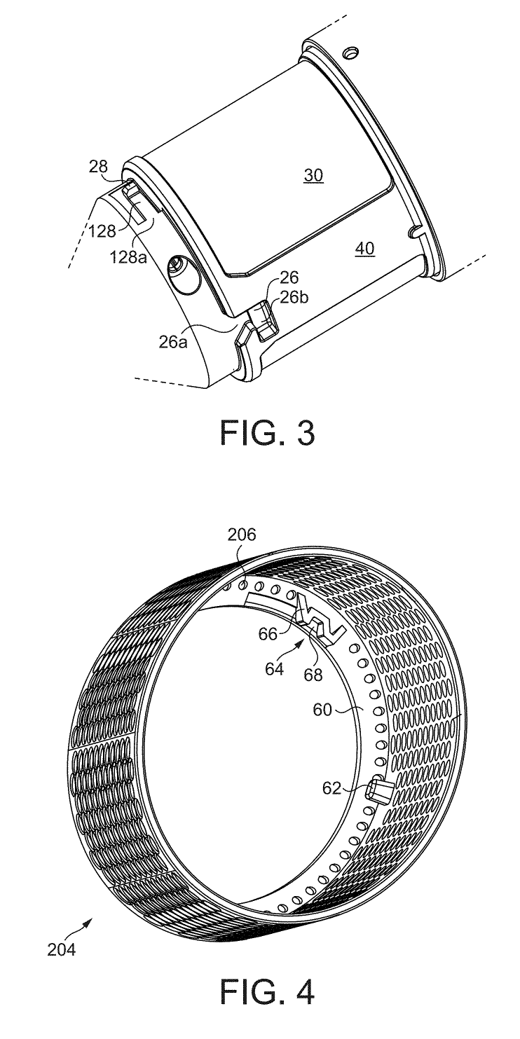

Referring in particular to FIGS. 2 and 3, the filter 224 is formed from two parts—the part that filters the flow is a thin metal foil 30 and a frame 40. The frame 40 provides a structure around the thin metal foil 30 preventing damage during manufacture and cleaning and it provides part of an attachment mechanism by which the filter grille 204 is retained with respect to the handle 210 of the appliance 10.

According to the invention, the filter grille 204 is retained with respect to the frame 40 via two connectors which are spaced apart and are different. Thus both the frame 40 and the filter grille 204 each comprise one part of each of the two connectors. The frame 40 has a number of different functions, one of which is to provide one half of the attachment mechanism by which the filter grille 204 is attached to the handle 210. The attachment mechanism on the frame 40 has two parts—a slot 26 and a biased retention pip 28 (also referred to herein as a retention detent).

The slot 26 is roughly “L” shaped so the filter grille 204 is pushed in a first direction along a first part 26a of the slot and then turned in a second direction along a second part 26b of the slot which is orthogonal to the first direction. The first direction is along the longitudinal axis X-X of the handle 210.

The biased retention pip 28 is formed on an arm 128 which is attached to the frame 30 at one end 128a and is free at the other end. The attached end acts like a hinge allowing the free end to move along an arc and this enables the deflection of the biased retention pip 28.

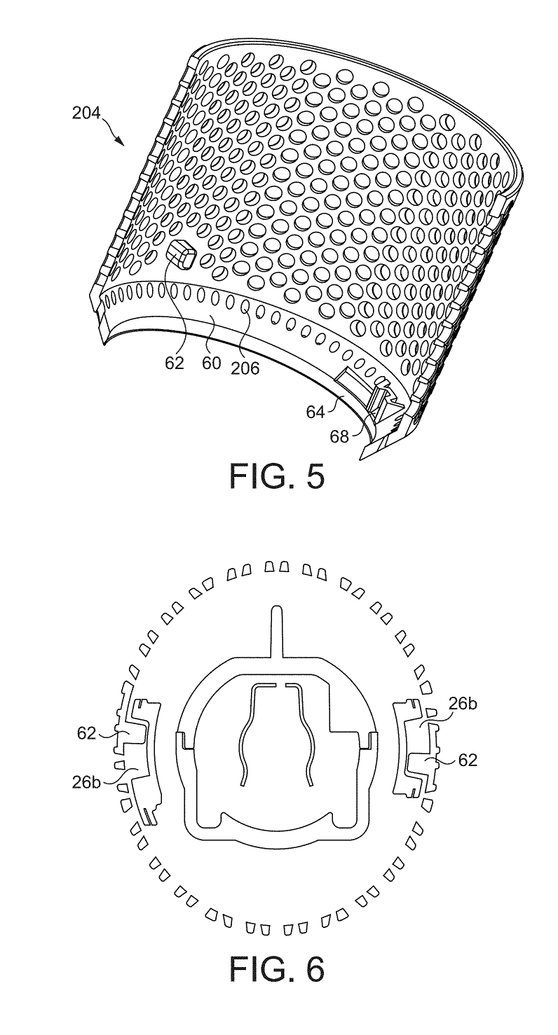

Referring to FIGS. 4 and 5 in particular, the filter grille 204 has a cooperating attachment mechanism which also has two parts. On the inner face 60 of the filter grille 204 a protrusion 62 is provided which extends radially inwards of the inner face 60. The protrusion 62 is adapted to fit within the slot 26. In addition a bump stop 64 is provided which is a further protrusion 66 which extends radially inwards of the inner face 60 and has a recess 68 adapted to receive the retention pip 28. Thus, as the filter grille 204 engages with the filter 224, the protrusion 62 engages with and moves along the first part 26a of the slot then, as the filter grille 204 is turned with respect to the frame 40 the protrusion moves along the second part 26b of the slot and the biased retention pip 28 engages with the further protrusion 66 which initially deflects the biased retention pip 28 however further rotation causes engagement of the biased retention pip 28 with the recess 68.

In order for a very stable connection, in one embodiment the frame 40 is provided with two slots 26 disposed diametrically opposite each other and two arms 128 which are radially spaced from each of the two slots 26. The filter grille 204 is also provided with two protrusions 62 and two further protrusions 66 with a spacing to match the slots 26 and arms 128. In this embodiment each part of the attachment mechanism is spaced 90° from adjacent parts, but this is not essential.

In addition, in this embodiment, the handle 210 is oval in cross-section and each part is positioned on either the major or minor radius of the handle 210 of the appliance. Again this is not essential and the invention herein described is suitable for other curving shapes such as a circular cross-section.

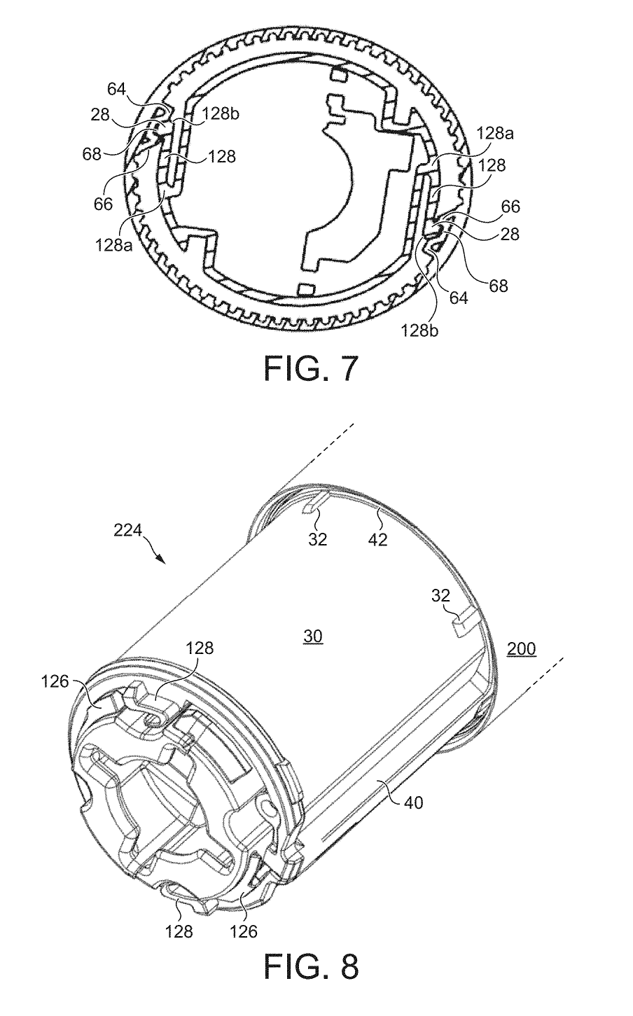

The further protrusion 66 gradually extends radially inwardly of the inner surface 60 of the filter grille 204 providing a sloped surface along which the retention pip 28 slides (FIG. 7). This provides a gradual deflection of the second end 128b of the pivotable arm 128 and conveniently provides space for the recess 68 in which the retention pip 28 is housed.

In this embodiment, there is both a vertical motion and a rotational motion required to engage and disengage the filter grille 204 from the filter 224. For this reason the two different attachment mechanisms are longitudinally displaced on the filter 224 and the filter grille 204. This results in the slot 26 being engaged by the protrusion 62 before the retention pip 28 engages with the recess 68.

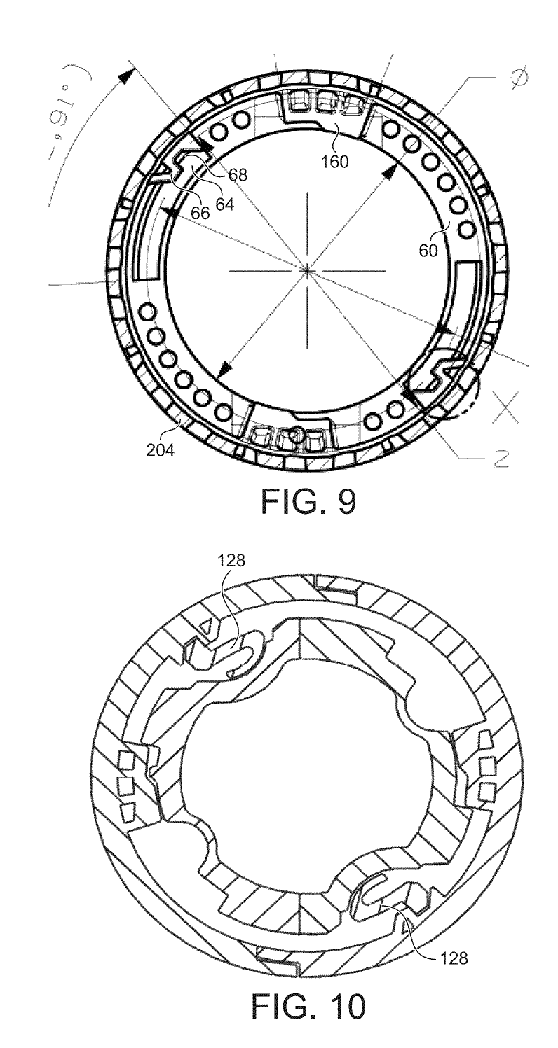

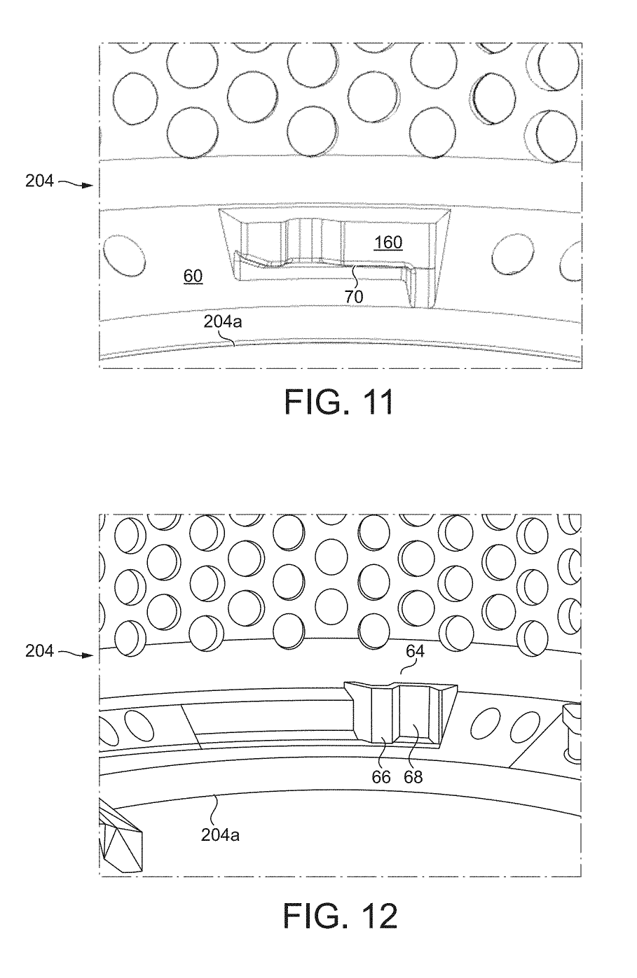

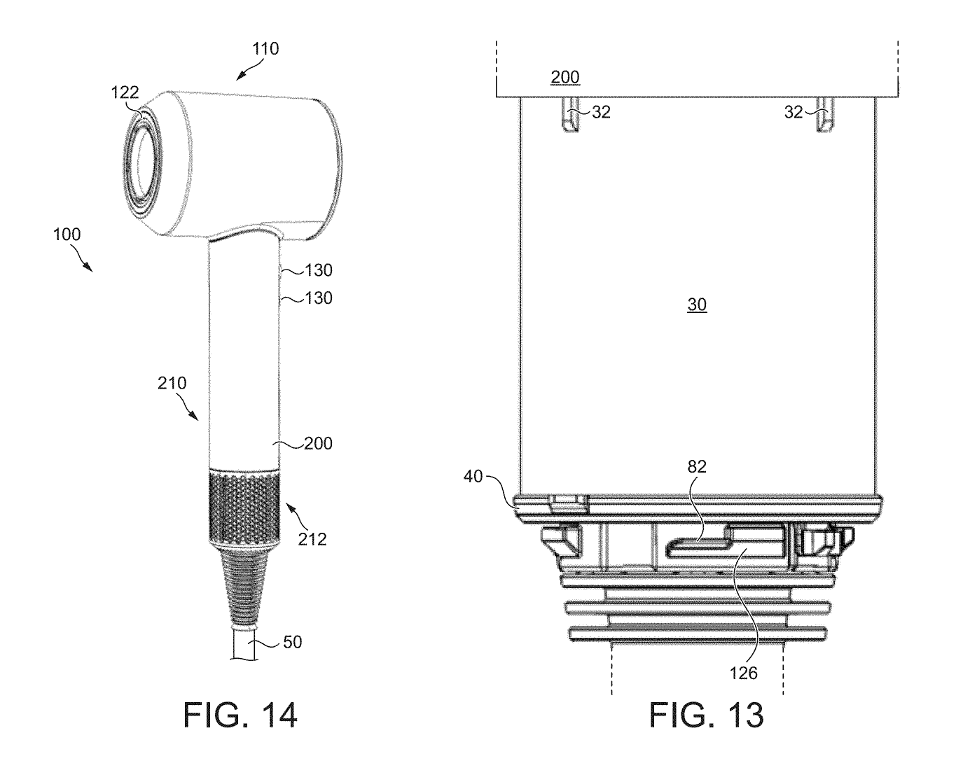

A second embodiment of the invention will now be described, referring to FIGS. 8 to 14. In this embodiment, components illustrated and already described in relation to FIGS. 1 to 7 have like reference numerals.

The appliance 100 is a hairdryer having a handle 210 and a body 110. The handle 210 has an outer wall 200 which a user holds and this provides a UI 130 comprising user operated buttons enabling the user to select between a number of different heat and flow settings. The outer wall 200 contains a fan unit and heater (both not shown). In use the fan unit draws fluid in through a fluid inlet 212, along an internal fluid flow path, through the heater which optionally heats the fluid which is then emitted by the fluid outlet 122 in the body 110. Power is supplied to the appliance 10 via a power cable 50 which extends from the appliance to a plug (not shown) at the distal end. The power cable 50 connects to the appliance 100 at the fluid inlet 212.

In this embodiment the handle 210 and thus the filter grille 204 and filter 224 are circular in cross section. The attachment mechanism comprises two parts which are spaced apart and different. However, in this embodiment, each part is not spaced 90° apart.

Again, in this embodiment a pair of each type of attachment means is provided as this gives good stability and mechanical connection between the filter grille 204 and the filter 224. However, one of each or even a different number of each type of attachment means could be used and is intended to fall within the scope of the claims.

On the filter 224, a pair of pivotable arms 128 are disposed diametrically opposite each other. Instead of the “L” shaped slots of the first embodiment, a pair of flanges 126 are provided and each one of the pair of flanges 126 are also disposed diametrically opposite each other however, the pair of flanges 126 are not positioned equidistant from each of the pair of pivotable arms 128.

The pair of flanges 126 extend radially outwards from the filter 224 towards the filter grille 204.

Referring to FIGS. 8, 11 and 13 in particular, the filter grille 204 has a cooperating slot 160 which extends radially inwards from an inner surface 60 of the filter grille 204. The pair of flanges 126 and the slots 160 have respective mating faces which slide over one another when the filter grille 204 is rotated with respect to the filter 224 and handle 210. The mating face 82 of the pair of flanges 126 is orthogonal to the longitudinal axis X-X of the handle 210. The mating face 82 of the pair of flanges 126 is directed towards the thin metal foil 30.

When the filter grille 204 is attached to the handle the mating face 70 of the cooperating slot 160 is orthogonal to the longitudinal axis X-X of the handle 210. The mating face 70 of the cooperating slot 160 is directed away from the thin metal foil 30 or towards a downstream end 204a of the filter grille. Thus, when the filter grille 204 is attached and rotated with respect to the handle 210, the respective mating faces 82, 70 slide over one another supporting the filter grille 204 at a point radially spaced from the sprung arm 128 and further protrusion 66. This provides a more secure attachment at the end of the appliance.

In order to support the filter grille 204 and maintain the correct positioning where it is adjacent the outer wall 200, a number of spaced apart ridges are provided. The ridges 32 are part of the frame 40 and extend from an end 42 (FIG. 8) of the frame 40 adjacent the outer wall 200 over the thin metal foil 30 for a short distance. The ridges 32 centralise the filter grille 204 and support the filter grille 204 distally from the attachment mechanism. The ridges 32, are adjacent the outer wall 200 of the handle 210 and distal to the attachment mechanism.

The difference features of the attachment mechanism could be provided in reverse for example, the slot and/or the arm on the filter grille instead of the filter.

The first part of the attachment mechanism could be formed as part of the inner wall rather than the filter.

1. A hand held appliance comprising a handle having a fluid inlet at a first end, the fluid inlet comprising an external grille and a filter, wherein the external grille is retained with respect to the filter by an attachment mechanism that comprises a first pair of connectors and a second pair of connectors, and wherein the first pair of connectors is spaced apart from and different than the second pair of connectors.

2. The appliance of claim 1, wherein the first pair of connectors and the second pair of connectors have different functions.

3. The appliance of claim 1, wherein the first pair of connectors comprises a first part and a second part which mechanically interlock.

4. The appliance of claim 3, wherein the first part and second part mechanically interlock during relative rotation.

5. The appliance of claim 3, wherein the mechanical interlock is releasable.

6. The appliance of claim 3, wherein the first part is biased towards the second part.

7. The appliance of claim 5, wherein the first part comprises a pivotable arm.

8. The appliance of claim 7, wherein the first part comprises a retention detent located on the pivotable arm.

9. The appliance of claim 8, wherein the second part comprises a recess adapted to accommodate the retention detent.

10. The appliance of claim 3, wherein the external grille comprises one of the first part and the second part and the filter comprises the other of the first part and the second part.

11. The appliance of claim 10, wherein the external grille comprises the second part.

12. The appliance of claim 11, wherein the external grille has a radially inner surface and a radially outer surface, and wherein a protrusion extends radially inwards of the radially inner surface.

13. The appliance of claim 12, wherein the protrusion extends gradually radially inwards around a portion of the circumference of the external grille.

14. The appliance of claim 12, wherein the protrusion comprises a recessed portion.

15. The appliance of claim 14, wherein the filter comprises the first part of the connector.

16. The appliance of claim 15, wherein the first part comprises a pivotable arm having a first end pivotally attached to the filter and a second end which is free to move and comprises a retention detent.

17. The appliance of claim 16, wherein when the external grille is rotated in one direction with respect to the filter, the retention detent engages with the protrusion and the second end of the arm deflects allowing further relative movement until the recessed portion is reached, and wherein the arm pivots towards an undeflected state and the retention detent is housed within the recessed portion.

18. The appliance of claim 17, wherein a relative movement in another direction reverses the engagement allowing the external grille to be removed from the filter.

19. The appliance of claim 3, wherein the second connector comprises a third part and a fourth part.

20. The appliance of claim 19, wherein the third part comprises a cooperating slot.

21. The appliance of claim 19, wherein the fourth part comprises a protrusion.

22. The appliance of claim 20, wherein the cooperating slot extends in first direction and a second direction.

23. The appliance of claim 22, wherein the handle extends along a longitudinal axis X-X and the first direction is parallel to the longitudinal axis.

24. The appliance of claim 22, wherein the second direction is substantially orthogonal to the first direction.

25. The appliance of claim 1, wherein the first pair of connectors and the second pair of connectors are longitudinally spaced apart.

26. The appliance of claim 25, wherein the handle extends along a longitudinal axis X-X and the first pair of connectors and the second pair of connectors are spaced apart along the longitudinal axis.

27. The appliance of claim 19, wherein the fourth part comprises a flange.

28. The appliance of claim 27, wherein the external grille has a radially inner surface and a radially outer surface, and wherein the flange comprises face which extends substantially orthogonally and radially inwards of the radially inner surface.

29. The appliance of claim 28, wherein the cooperating slot comprises a further face adapted to engage with the face of the flange when the external grille is retained with respect to the filter.

30. The appliance of claim 1, wherein the filter comprises at least one ridge extending between the filter and the filter grille.

31. The appliance of claim 30, wherein the at least one ridge is located distal to the attachment mechanism.

32. The appliance of claim 30, wherein the at least one ridge is located adjacent the outer wall of the handle.

33. The appliance of claim 1, wherein the appliance is a hair care appliance.

34. The appliance of claim 33, wherein the hair care appliance is a hot styling appliance.

35. The appliance of claim 33, wherein the hair care appliance is a hairdryer.
